(19) United States
(12) Patent Application Publication
(10) Pub. No.: US 2008/0122150 A1
(43) Pub. Date: May 29, 2008

(54) CAM MAGNET ASSEMBLY AND METHOD THEROF

(75) Inventor: Ted Kegeris, Fairland, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: JVI Magnetics, Inc., Fountaintown, IN (US)

(21) Appl. No.: 11/876,235

(22) Filed: Oct. 22, 2007

Related U.S. Application Data
(60) Provisional application No. 60/862,324, filed on Oct. 20, 2006.

(51) Int. Cl. B25B 11/00

(52) U.S. Cl. 269/8

(57) ABSTRACT

A cam magnet assembly including at least one magnet, a rotatable cam situated within an opening that divides the at least one magnet into first and second magnetic portions, and a moveable arm connected to the cam and extending from the opening between the first and second magnetic portions to facilitating removal of the cam magnet assembly from a construction element via rotation of the cam.

### CROSS-REFERENCE TO RELATED APPLICATION

This application claims priority of U.S. Provisional Patent Application No. 60/862,324, filed on Oct. 20, 2006, in the United States Patent & Trademark Office, the disclosure of which is incorporated herein by reference in its entirety.

### BACKGROUND OF THE INVENTION

1. Field of the Invention

The present general inventive concept relates generally to a cam magnet assembly, and more particularly, to a magnet having an arm attached to a rotatable cam that is extendable from the magnet to facilitate removal of the magnet during use in construction applications.

2. Description of the Related Art

Construction applications generally involve transporting, connecting, and otherwise maneuvering various pieces of material. Some applications involve very large pieces of material and/or pieces of material having awkward shapes. Such pieces present a user with significant difficulty with respect to maneuvering the pieces during construction.

Convention methods generally require a user and several assistant users to assist with maneuvering large and/or awkward pieces of material. As such, conventional methods present a difficult process, require additional manpower, and are therefore inefficient.

Also involved in construction applications is a variety of construction equipment, some of which is required to be secured in place during use. One such piece of equipment is a hole former, which is used in the Precast Industry to create a hole for pipes to enter manholes. Manholes range in diameter from 4′ to over 10′ with varying depths.

Convention methods either bolt the hole former to a steel core of the manhole or shell, or position and tie the hole former to steel wire mesh, which is around the core. Both methods are time consuming, requiring the user to spend extra time attaching and detaching the hole former. Other disadvantages of these methods include that the hole former and steel core must both be pre-drilled with a bolt hole, which lowers the mechanical integrity of both. Further, tying the hole former does not present a secure means of engagement.

### SUMMARY OF THE INVENTION

A principal object of the present general inventive concept is to provide a cam magnet that is easy to assemble, easy to use, and affords repeated use without drilling holes.

Another object of the present general inventive concept is to provide a magnet of industrial strength with a moveable arm.

One advantage of the present general inventive concept with respect to use with a hole former is that the cam magnet 1 provides flexibility for placement without drilling holes in the core or jacket. The cam magnet 1 also provides a more secure engagement as opposed to conventional methods using steel wire mesh.

The foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept and various features thereof.

### BRIEF DESCRIPTION OF THE DRAWINGS

A preferred embodiment of the present general inventive concept, illustrative of the best mode in which the applicant has contemplated applying the principles, is set forth in the following description and is illustrated in the drawings.

FIG. 1 illustrates a cam magnet according to an exemplary embodiment of the present general inventive concept illustrating the magnet coupled with an arm and at least two plates coupled on either side of the magnet.

FIG. 2 illustrates the cam magnet of FIG. 1 with a moveable and adjustable arm.

FIG. 3 illustrates the cam magnet of FIG. 1.

FIG. 4 illustrates another embodiment of a cam magnet illustrating two notches on either end of the cam magnet.

FIG. 5 illustrates the cam magnet of FIG. 4.

FIG. 6 illustrates the cam magnet of FIG. 4 with an adjustable arm.

FIG. 7 illustrates the cam magnet of FIG. 1 with a cross section of the cam magnet and top view and end view.

FIG. 8 illustrates the cam magnet of FIG. 4.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept be referring to the figures.

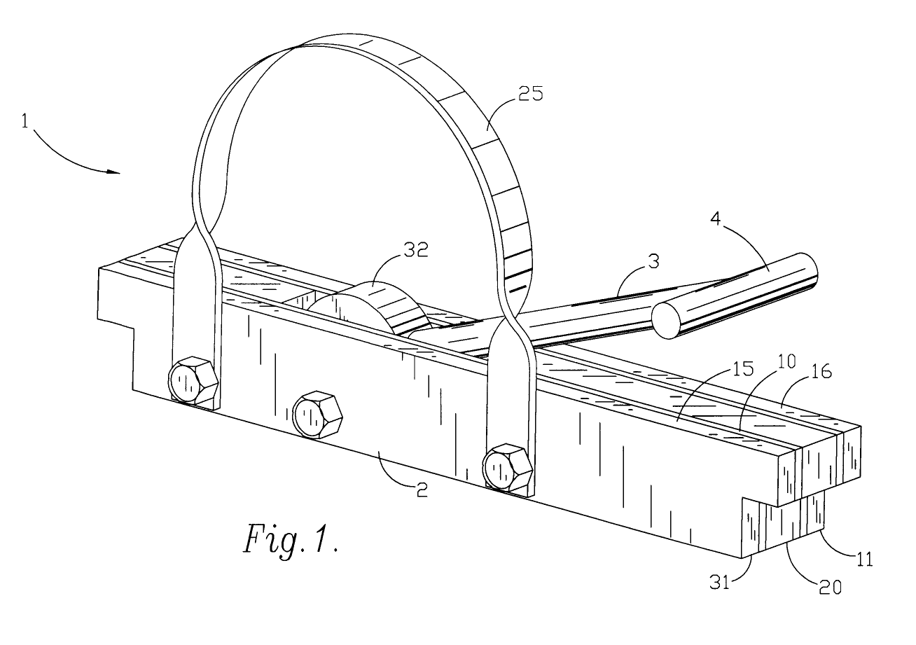

FIG. 1 illustrates a cam magnet 1 having a body 2 and an arm 3 coupled together at a point of rotation 7. The body 2 has two plates 15 and 16 on either side of a magnet 20 and the arm 3. The two plates 15 and 16 are separated from the magnet 20 via connector layers 10 and 11 located on either side of the magnet 20. The two plates 15 and 16 engage a side of the connector layers 10 and 11 opposite to another side of the connector layers 10 and 11 that engages the magnet 20 to sandwich all three elements 10, 11, and 20 together.

The arm 3 is rotatable around the axis of rotation 7 located within the body 2, and is adjustable to various angles along the axis of rotation 7. The arm 3 connects to a rotating disk or cam 30 situated in an opening 5 in the magnet 20 that divides magnet 20 into two portions. A handle portion 4 is attached to an end of the arm 3 to facilitate movement from a first position to a second position. The arm 3 abuts either portion of the magnet 20 in either first and second positions. Because the arm is metallic, the abutting engagement of the arm 3 with the magnet 20 allows the magnet 20 to magnetically secure the arm 3 in either position to avoid inadvertent movement of the arm 3 during use.

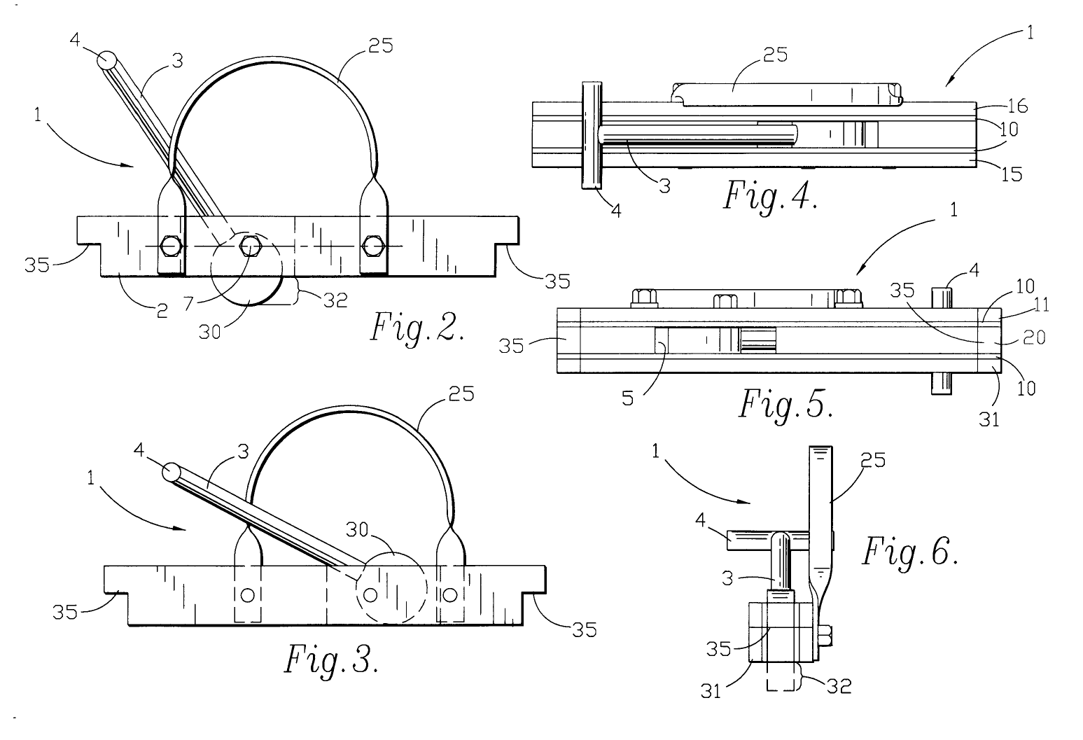

The cam 30 is mounted at a location off-center from a center of the cam 30 to convert circular movement of the arm 3 to linear motion. Specifically, as the arm 3 swings from the first position, illustrated in FIG. 1, to the second position, illustrated in FIG. 2, the cam 30 rotates and breaks a planar surface 31 of the magnet 20 to expose a cam extension portion 32. The purpose of the cam extension portion 32 will be discussed hereafter.

In the exemplary embodiment, the cam magnet 1 has at least one notch 35 in one or both ends of the body to secure fixtures in a desired location. In another embodiment, the cam magnet 1 has at least two sides that float or move and can be adjusted and then fixed into place to increase adaptability of the cam magnet 1. The notch 35 or floating sides allow use with concave or convex surfaces. An example of such use includes is for utility plant products, such as manholes and catch basins. Length, width, height, shape, and magnetic strength of the cam magnet 1 may vary depending on a user's application needs.

During use, the cam magnet 1 may be attached to construction material (not illustrated) with the arm 3 in the first position. The cam magnet 1 facilitates maneuvering of the material to provide easier processing.

When the user desires to remove the cam magnet 1 from the material, the arm 3 can be moved to the second position to rotate the cam 30 and extend the extension portion 32 away from the cam magnet 1 and toward the material. The extension portion 32 moves the magnet 1 away from the material, thereby creating a gap, which weakens the magnetic connection between the cam magnet 1, thus facilitating removal of the cam magnet 1 from the material.

Another use of the cam magnet 1 is in combination with a utility hole former. The cam magnet 1 can be formed with the notch 35 that is sized and shaped to engage with a side or other parts of the hole former, such as a donut ring on an inside of the hole former. The cam magnet 1 and hole former are then placed in position on a steel core of a manhole or shell.

In one preferred embodiment, the cam magnet 1 has at least tapped hole (not illustrated) for coupling with an attachment plate. The attachment plate sits on top of the cam magnet 1 and is coupled to the cam magnet 1 using screws or other means. The cam magnet 1 and attachment plate are attached to steel side rails or parts, which need to be secured in a position.

Having now described the features, discoveries and principles of the general inventive concept, the manner in which the general inventive concept is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A cam magnet assembly comprising:
at least one magnet;
a cam situated within an opening that divides the at least one magnet into first and second magnetic portions; and
a moveable arm connected to the cam and extending from the opening between the first and second magnetic portions.

2. The cam magnet assembly according to claim 1, wherein the moveable arm swings from a first position to a second position.

3. The cam magnet assembly according to claim 2, wherein the moveable arm is secured in the first position by the first magnetic portion and is secured in the second position by the second magnetic portion.

4. The cam magnet assembly according to claim 2, wherein the cam is nested entirely within the cam magnet when the moveable arm is in the first position and extends out of the cam magnet when the moveable arm is in the second position.

5. The cam magnet assembly according to claim 1, further comprising:
a plurality of connection layers, one on either side of the first and second magnetic portions; and
a plurality of outer plates, one on either side of the connection layer,
wherein the plurality of connection layers join the first and second magnetic portions to the plurality of outer plates.

6. The cam magnet assembly according to claim 5, wherein the plurality of connection layers and the plurality of outer plate layers are configured to define a magnetic focal direction.

7. The cam magnet assembly according to claim 5, wherein the plurality of connection layers and the plurality of outer plate layers are configured to provide a buffer zone between the first and second magnetic portions and an outer surface of the outer plate layers.

8. The cam magnet assembly according to claim 1, further comprising:
a notched portion on the first and second magnetic portions.

9. The cam magnet assembly according to claim 1, further comprising:
a handle attached to an outer surface of one of the plurality of outer plate layers.

10. A method of using a cam magnet assembly comprising:
providing two magnets that are aligned parallel to each other with a gap therebetween, and connected to each other by at least two side plates with a
providing a rotatable cam within the gap having an arm extending from a side thereof;
magnetically attaching the cam magnet assembly to a construction element to maneuver the construction element;
facilitating removal of the cam magnet assembly from the construction element via rotation of the cam.

11. A method of using a cam magnet assembly comprising:
providing two magnets that are aligned parallel to each other with a gap therebetween, and connected to each other by at least two side plates with a
providing a rotatable cam within the gap having an arm extending from a side thereof;
providing a notch in at least one of the two magnets;
inserting a portion of a construction machine into the notch;
magnetically attaching the cam magnet assembly and construction machine to a construction element to secure the construction machine to the construction element;
facilitating removal of the cam magnet assembly from the construction element via rotation of the cam.
